(19) United States
(12) Patent Application Publication
(10) Pub. No.: US 2010/0325389 A1
(43) Pub. Date: Dec. 23, 2010

(54) Microprocessor communications system

(76) Inventors: Charles H. Moore, Sierra City, CA (US); Jeffrey Arthur Fox, Berkeley, CA (US); John W. Rible, Santa Cruz, CA (US)

Correspondence Address: HENNEMAN & ASSOCIATES, PLC, 70 N. MAIN ST., THREE RIVERS, MI, 49093, US

(21) Appl. No.: 12/080,826

(22) Filed: Apr. 4, 2008

(51) Int. Cl. G06F 15/76; G06F 9/02

(52) U.S. Cl. 712/30; 712/E09.002

(57) ABSTRACT

A microprocessor communications system utilizes a combination of an activity status monitor register and one or more address select registers to read from a communications port of one processor and write to a communications port of an adjacent processor in a single instruction word loop. This circumvents the requirement to save and retrieve data and/or instructions from memory. A stack register selector contains a plurality of stack registers and a plurality of shift registers, which are interconnected. The stack registers are selected by the shift registers in such a way that the stack registers operate in a circular repeating pattern, which prevents overflow and underflow of stacks.

### BACKGROUND OF THE INVENTION

1. Technical Field

The present invention generally relates to electrical computers, and more particularly to interconnected computers and their communications systems.

2. Description of the Background Art

In the art of computing, processing speed is a much desired quality, and the quest to create faster computers and processors is ongoing. However, it is generally acknowledged in the industry that the limits for increasing the speed in microprocessors are rapidly being approached, at least using presently known technology. Therefore, there is an increasing interest in the use of multiple processors to increase overall computer speed by sharing computer tasks among the processors.

The use of multiple processors creates a need for communication between the processors. Therefore, there is a significant portion of time spent in transferring instructions and data between processors. Each additional instruction that must be executed in order to accomplish this places an incremental delay in the process which, cumulatively, can be very significant. The conventional method for communicating instructions or data from one computer to another involves first storing the data or instruction in the receiving computer and then, subsequently calling it for execution (in the case of an instruction) or for operation thereon (in the case of data). In addition, the use of multiple processors usually requires numerous address locators or pointers.

To satisfy the need to allow multiple read and write operations in various different directions—that is, between any of various other CPUs in the same system—all at the same time, systems and methods for multi-port read and write operations have been developed. These address most of the concerns discussed above but, as with any major advancement, these systems and methods have raised new challenges. For example, in multi-CPU environments were the CPUs are arranged in a pipeline or a multidimensional array, inversion can occur where a CPU writes to a prior rather than a subsequent CPU. Mechanisms can be crafted to prevent this, but these entail hardware modifications or substantial programming and inter-CPU communications. As another example, many applications today require real time processing or it is simply desirable to increase processing speed and efficiency. It follows that optimization of multi-port read and write operations would be beneficial. In a similar vein, now that multi-port operations are available, it would also be beneficial to make the set-up and the performance of these operations more flexible.

A high performance microprocessor and an efficient interconnection network between multiple microprocessors are needed in order to minimize the number of computational steps in performing a task.

### BRIEF SUMMARY OF THE INVENTION

It is an object of the presently described invention to achieve increased processing speed of interconnected multiple processors. This is achieved in part by the use of efficient processor architecture and efficient communication transfer between processors.

The presently described invention discloses a communications system in which data and/or instructions are transferred repeatedly from one processor to a neighboring processor with a single instruction word programming loop. This communications system can be utilized, for example by one processor using a second processor for data storage, then retrieving that data at a later time. Another example of the use of the presently described communications system is for a second processor to compute results from data transferred from a first processor. The computed results could be stored by the second processor, then transferred back to the first processor.

The increased processing speed of the disclosed communications system is also achieved by an improved processor architecture, which includes multiple address select registers and an activity status monitor register. The activity status monitor register of a processor gives the present read and write status of all neighboring processors, and gives the input and output status of all pin connections. An address select register provides an address indicator for each neighboring communications port and an indicator to check the activity status monitor register. These combined registers provide a means of reading from one port and writing to another port in a single instruction word loop.

The increased processing speed of the disclosed communications system is also achieved by a presently described stack register selector. A multitude of stack registers are selected in such a way as to operate in a circular repeating pattern. This is achieved by an interconnected stack of shift registers. Each shift register has a read line connected to a respective stack register, and each shift register has a write line connected to a respective stack register. A series of read instructions result in repeated sequential selection of stack registers in a circular pattern. A series of write instructions result in repeated sequential selection of stack registers in an oppositely directed circular pattern. These circular repeating patterns of the stack registers avoid overflow and underflow of stacks that occur in a conventional based stack computer.

### BRIEF DESCRIPTION OF THE DRAWINGS

FIG. 1 is a diagrammatic view of a computer array in accordance with the present invention;

FIG. 2 is a detailed diagram showing a subset of the computers of FIG. 1 and a more detailed view of the interconnecting data buses of FIG. 1;

FIG. 3 is a block diagram depicting a general layout of one of the computers of FIGS. 1 and 2;

FIGS. 4 and 5 are a combined schematic representation of a first stack register selector in accordance with the present invention;

FIG. 6 is a table depicting the shift register order of selection for a first stack register selector of FIGS. 4 and 5;

FIG. 7 is a block diagram depicting the selected order of stack registers for a read instruction and a write instruction in accordance with the present invention;

FIGS. 8 and 9 are a combined schematic representation of a second stack register selector in accordance with the present invention;

FIG. 10 is a table depicting the shift register order of selection for a second stack register selector of FIGS. 8 and 9;

FIGS. 11a-11f are diagrammatic representations of an instruction register and an instruction word, respectively that are used in the computers of FIGS. 1 and 2—for “FIGS. 11a and 11b are diagrammatic representations of an instruction register and an instruction word, respectively that are used in the computers of FIGS. 1 and 2” in the drat Brief description of the drawings;

FIG. 12 is a schematic representation of a slot sequencer used in the computers of FIGS. 1 and 2;

FIG. 13 is a is a diagrammatic representation of an instruction word or micro-loop that is usable in the computers of FIGS. 1 and 2 in accordance with the present invention; and

### DETAILED DESCRIPTION OF THE INVENTION

While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

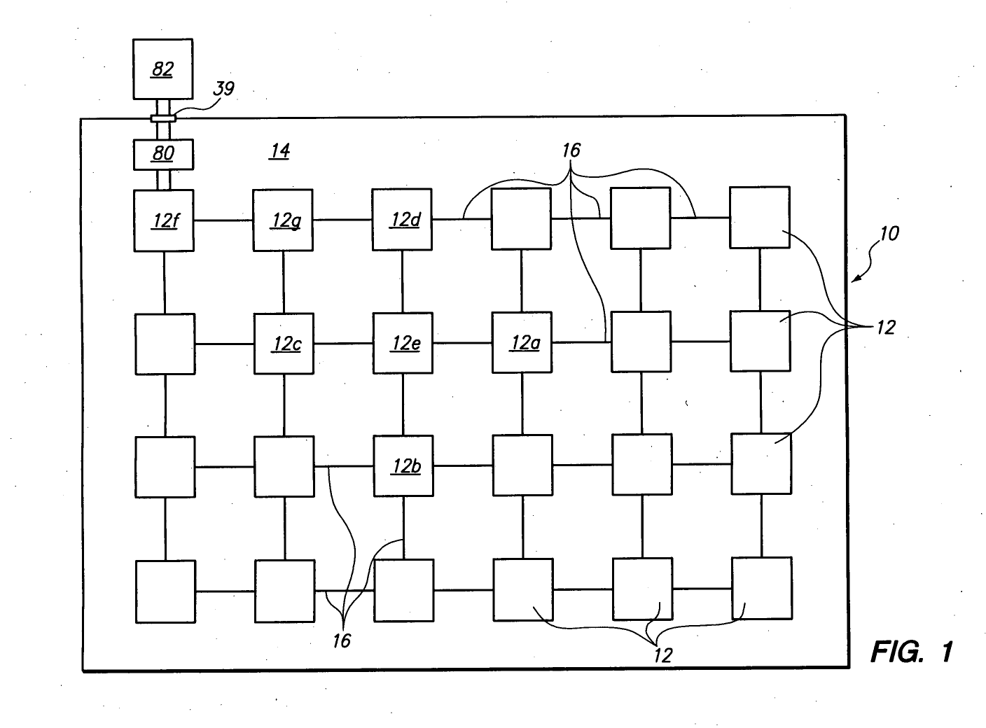

As context and a foundation to the present invention, a detailed example of asynchronous computer communication is first presented. For this example, a computer array is depicted in a diagrammatic view in FIG. 1 and is designated therein by the general reference character 10. The computer array 10 has a plurality (twenty four in the example shown) of computers 12 (sometimes also referred to as “cores” or “nodes” in the example of an array). In the example shown, all of the computers 12 are located on a single die 14. Each of the computers 12 is a generally independently functioning computer, as will be discussed in more detail hereinbelow. The computers 12 are interconnected by a plurality of interconnecting data buses 16 (the quantities of which will be discussed in more detail hereinbelow). In this example, the data buses 16 are bidirectional asynchronous high speed parallel data buses, although it is within the scope of the technology here that other interconnecting means might be employed for the purpose. As a further example, the plurality of interconnections between computers is a point-to-point link or a point-to-point connection, where a point-to-point link is a dedicated link that connects exactly two computers or two nodes of an array.

In the present embodiment of the array 10, not only is data communication between the computers 12 asynchronous, but the individual computers 12 also operate in an internally asynchronous mode. This has been found to provide important advantages. For example, since a clock signal does not have to be distributed throughout the computer array 10, a great deal of power is saved. Furthermore, not having to distribute a clock signal eliminates many timing problems that could limit the size of the array 10 or cause other difficulties.

One skilled in the art will recognize that there will be additional components on the die 14 that are omitted from the view of FIG. 1 for the sake of clarity. Such additional components include power buses, external connection pads, and other such common aspects of a microprocessor chip.

Computer 12e is an example of one of the computers 12 that is not on the periphery of the array 10. That is, computer 12e has four orthogonally adjacent computers 12a, 12b, 12c and 12d. This grouping of computers 12a through 12e will be used hereinafter in relation to a more detailed discussion of the communications between the computers 12 of the array 10. As can be seen in the view of FIG. 1, interior computers such as computer 12e will have four other computers 12 with which they can directly communicate via the buses 16. In the following discussion, the principles discussed will apply to all of the computers 12 except that the computers 12 on the periphery of the array 10 will be in direct communication with only three or, in the case of the corner computers 12, only two other of the computers 12.

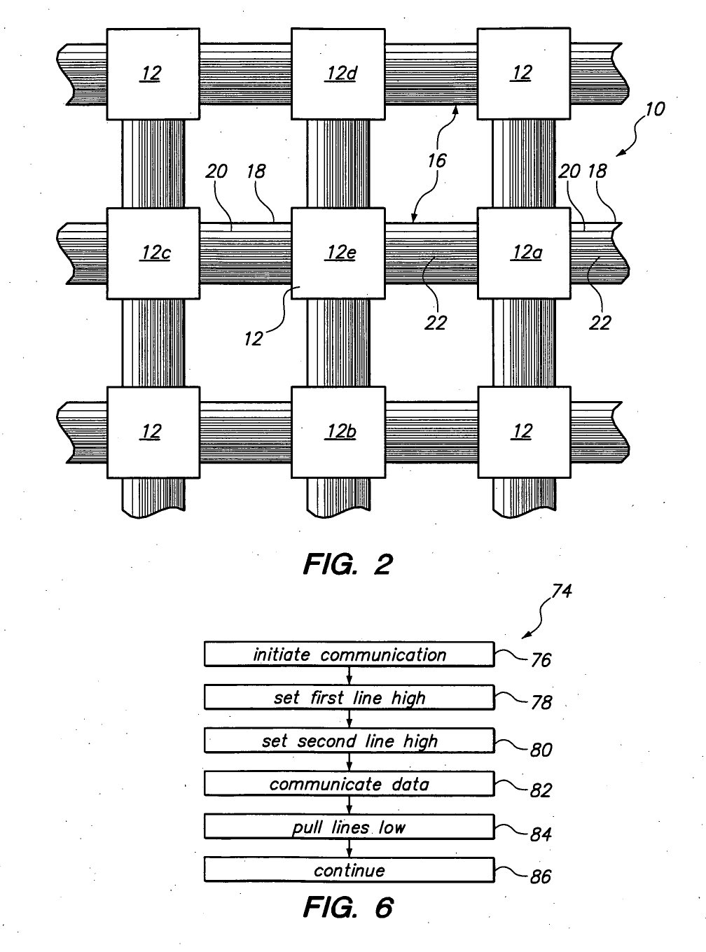

FIG. 2 is a more detailed view of a portion of FIG. 1 showing only some of the computers 12 and, in particular, computers 12a through 12e, inclusive. The view of FIG. 2 also reveals that the data buses 16 each have a read line 18, a write line 20 and a plurality (eighteen, in this example) of data lines 22. The data lines 22 are capable of transferring all the bits of one eighteen-bit instruction word generally simultaneously in parallel. It is also within the scope of the technology here that data line connections other than 18 data lines could be used. As examples thereof, 16, 20, 21, 24, or 32 data lines could be used, which correspond, respectively, to a 16, 20, 21, 24, or 32 bit instruction word. It should be noted that, in an alternate embodiment, some of the computers 12 are mirror images of adjacent computers.

A computer 12, such as the computer 12e, can set one, two, three or all four of its read lines 18 such that it is prepared to receive data from the respective one, two, three or all four adjacent computers 12. Similarly, it is also possible for a computer 12 to set one, two, three or all four of its write lines 20 high. (Both cases are discussed in more detail hereinbelow.)

When one of the adjacent computers 12a, 12b, 12c or 12d sets a write line 20 between itself and the computer 12e high, if the computer 12e has already set the corresponding read line 18 high, then a word is transferred from that computer 12a, 12b, 12c or 12d to the computer 12e on the associated data lines 22. Then the sending computer 12 will release the write line 20 and the receiving computer 12e (in this example) pulls both the write line 20 and the read line 18 low. The latter action will acknowledge to the sending computer 12 that the data has been received. Note that the above description is not intended necessarily to denote the sequence of events in order. In actual practice, the receiving computer may try to set the write line 20 low slightly before the sending computer 12 releases (stops pulling high) its write line 20. In such an instance, as soon as the sending computer 12 releases its write line 20, the write line 20 will be pulled low by the receiving computer 12e.

In the present example, only a programming error would cause both computers 12 on the opposite ends of one of the buses 16 to try to set the read line 18 there-between high and set the write line 20 there-between high at the same time. However, it is presently anticipated that there will be occasions wherein it is desirable to set different combinations of the read lines 18 high such that one of the computers 12 can be in a wait state awaiting data from the first one of the chosen computers 12 to set its corresponding write line 20 high.

In the example discussed above, computer 12e was described as setting one or more of its read lines 18 high before an adjacent computer (selected from one or more of the computers 12a, 12b, 12c or 12d) has set its write line 20 high. However, this process can certainly occur in the opposite order. For example, if the computer 12e were attempting to write to the computer 12a, then computer 12e would set the write line 20 between computer 12e and computer 12a to high. If the read line 18 between computer 12e and computer 12a has then not already been set to high by computer 12a, then computer 12e will simply wait until computer 12a does set that read line 18 high. Then, as discussed above, when both of a corresponding pair of read line 18 and write line 20 are high, the data awaiting to be transferred on the data lines 22 is transferred. Thereafter, the receiving computer 12a (in this example) sets both the read line 18 and the write line 20 between the two computers 12e and 12a (in this example) to low as soon as the sending computer 12e releases it.

Whenever a computer 12 such as the computer 12e has set one of its write lines 20 high in anticipation of writing, it will simply wait, using essentially no power, until the data is “requested,” as described above, from the appropriate adjacent computer 12, unless the computer 12 to which the data is to be sent has already set its read line 18 high, in which case the data is transmitted immediately. Similarly, whenever a computer 12 has set one or more of its read lines 18 to high in anticipation of reading, it will simply wait, using essentially no power until the write line 20 connected to a selected computer 12 goes high to transfer an instruction word between the two computers 12.

There may be several potential means and/or methods to cause the computers 12 to function as described above. However, in this present example, the computers 12 so behave simply because they are operating generally asynchronously internally (in addition to transferring data there-between in the asynchronous manner described). That is, instructions are completed sequentially. When either a write or read instruction occurs, there can be no further action until that instruction is completed (or, perhaps alternatively, until it is aborted, as by a “reset” or the like). There is no regular clock pulse, in the prior art sense. Rather, a pulse is generated to accomplish a next instruction only when the instruction being executed either is not a read or write type instruction (given that a read or write type instruction would require completion by another entity) or when the read or write type operation is in fact completed.

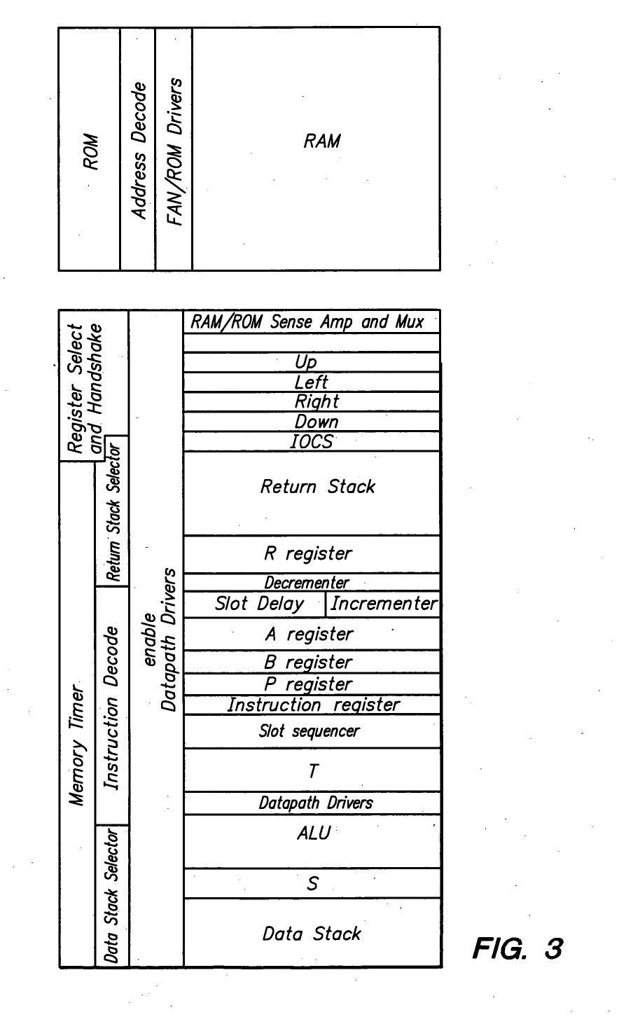

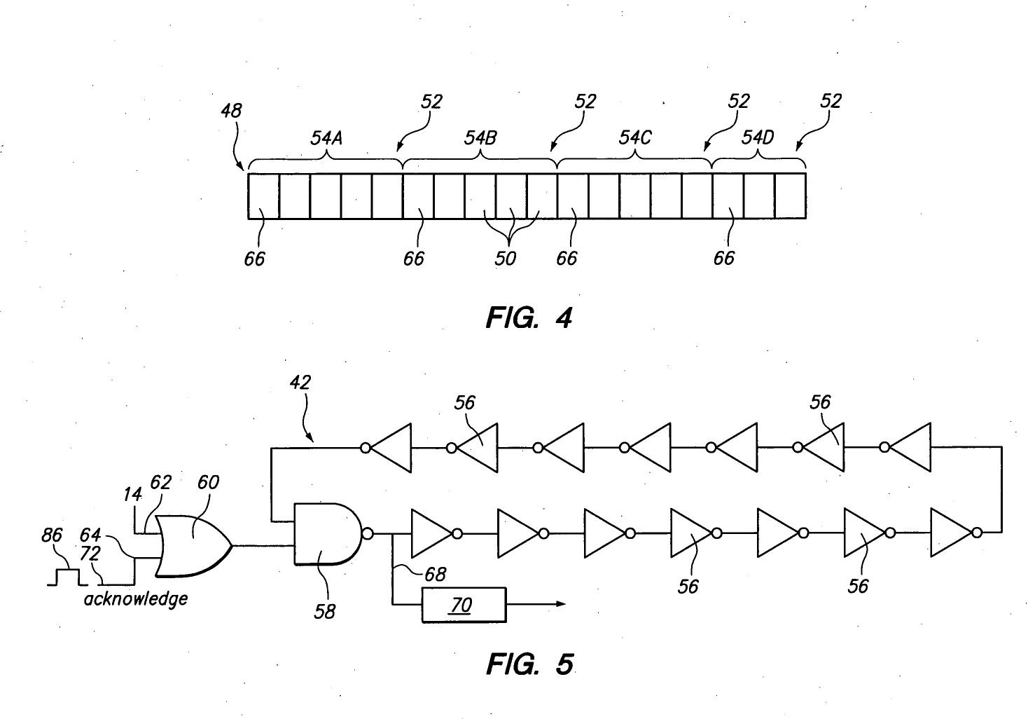

FIG. 3 is a block diagram depicting the general layout of an example of one of the computers 12 of FIGS. 1 and 2. Each of the computers 12 is a generally self contained computer 12 having its own RAM 24 and ROM 26. Other basic components of the computer 12 include a return stack 28 and an associated R register 29, an arithmetic logic unit (ALU) 32, a data stack 34 and an associated T register 44 and S register 46. An instruction area contains an 18-bit instruction register 30a which accommodates an 18-bit instruction word, and the instruction area also contains a five-bit opcode register which accommodates a single 3-5 bit instruction that is currently being executed. The execution of instructions and instruction words will be described in greater detail hereinbelow with reference to FIG. 4.

As mentioned previously, the computers 12 are also sometimes referred to as individual “cores,” given that they are, in the present example, combined on a single chip. One skilled in the art will be generally familiar with the operation of stack based computers such as the computers 12 of this present example. The computers 12 are dual stack computers having the data stack 34 and separate return stack 28.

In this embodiment, the computer 12 has four communication ports 38 for communicating with adjacent computers 12. The communication ports 38 are tri-state drivers, having an off status, a receive status (for driving signals into the computer 12) and a send status (for driving signals out of the computer 12). If the particular computer 12 is not on the interior of the array 10 (FIG. 1) such as the example of computer 12e, then one or more of the communication ports 38 will not be used in that particular computer, at least for the purposes described herein. There are also a number of other registers 40, which in this example are an A register 40a, a B register 40b, a P register 40c, and an I/O control and status register (IOCS register) 40d. In this example, the A register 40a, the IOCS register 40d, and the instruction register 30a are full eighteen-bit registers, while the B register 40b and the P register 40c are nine-bit registers.

FIG. 3 also illustrates a register select and handshake 74, a return stack selector 72 and a data stack selector 73. The register select and handshake 74 establishes proper protocol for a communications channel between a register 40 and a port 38 before operations begin to make certain that data moves back and forth properly between them. The return stack selector 72 and data stack selector 73 each comprise a shift register. The shift register contains a stack of one-bit registers, where each one-bit register of the shift register corresponds to each 18-bit register of the return stack 28 or data stack 34. A high value within a bit register of the shift register will select or point to its corresponding 18-bit register in the return stack 28 or data stack 34.

Also depicted in block diagrammatic form in the view of FIG. 3 is a RAM/ROM sense amp and multiplexer 76, datapath enable drivers 71a, datapath drivers 71b, RAM/ROM enable drivers 70, a slot sequencer 42, a memory timer 75, a slot delay 79, an instruction decode 36b, an address decode 36a, a decrementer 77, and an incrementer 78. These are described in detail immediately hereinbelow.

The RAM/ROM sense amp and multiplexer 76 selects either RAM 24 or ROM 26 as one of two inputs to put onto the input data bus. The address decode 36a selects which RAM 24 memory cells are connected to the 18 bit lines running to the sense amp multiplexer 76. When RAM 24 or ROM 26 is selected as the output, then the 18 RAM or ROM bit lines from the sense amp connect to the instruction register 30a or to the T register 44 input.

RAM 24 contains 18 bit lines, or vertical columns. There are 36 cells in each row of RAM 24, and RAM 24 contains 32 rows. Each row of RAM 24 contains two groups of 18 cells each. A RAM 24 memory address contains the column and row location of one 18-bit word, or one group of 18 cells.

ROM 26 contains 64 rows. Each row of ROM 26 contains one 18-bit word, where each word contains one bit from each of the eighteen one-bit lines. A ROM 26 memory address contains the row of the one 18-bit word.

Datapath drivers 71b drive the signal from the T register 44 to any of the B register 40b, the A register 40a, the R register 29, the IOCS register 40d, to any of the ports 38, or to RAM 24. RAM/ROM enable drivers 70 enable a pass gate between memory cells and input of the sense amps. Pass gates connect memory and ports 38 to either the instruction register 30a or the T register 44; other pass gates connect I/O pads and port status to the T register 44 only. A datapath enable driver 71a enables a signal or data into a register via a pass gate.

The slot sequencer 42 selects the next 3-5 bits of opcode from the current 18-bit word that are to be executed, and if it has an address, the slot sequencer 42 identifies whether the address of that opcode has a RAM/ROM memory address, a port address, or an IOCS address. The number of cycles required for a port address or IOCS instruction differs from the number of cycles required for a memory address instruction. The memory timer 75 sets the required timing based upon whether RAM/ROM memory, or a port 38 or IOCS has been addressed. The slot delay 79 determines when the slot sequencer 42 can fetch the next opcode, and the memory timer 75 makes any necessary delays in timing when accessing memory or the ports 38 or IOCS.

Instruction decode 36b copies the 3-5 bits in the current slot from the instruction register 30a into the opcode register. If the instruction is a JUMP, CALL, or conditional BRANCH, then the address decode 36a will determine if the address of the instruction in the opcode register is a memory address (bit 8=0) or a port address or IOCS (bit 8=1). If the address is directed to memory, then bit 7 determines if the memory address is directed to RAM (bit 7=0) or ROM (bit 7=1).

The decrementer 77 is used, as an example with NEXT and MICRO-NEXT instructions to decrement the R register 29 of the return stack 28 towards zero. The incrementer 78 is used for automatic incrementing of the relevant registers selected by the opcode in an instruction word. As an example, an instruction word containing FETCH p+ or STORE p+ would automatically increment the P register 40c. An instruction word containing FETCH a+ or STORE a+ would automatically increment the A register 40a.

Although the technology is not limited by this example, the present computer 12 is implemented to execute native Forth language instructions. As one familiar with the Forth computer language will appreciate, complicated Forth instructions, known as Forth “words”, are constructed from the native processor instructions designed into the computer. The collection of Forth words is known as a “dictionary”. In other languages, this might be known as a “library”. As will be described in greater detail hereinbelow, the computer 12 reads eighteen bits at a time from RAM 24, ROM 26, or directly from one of the data buses 16 (FIG. 2). However, since most instructions in Forth (known as operand-less instructions) obtain their operands directly from the stacks 28 and 34, they are generally only five bits in length such that up to four instructions can be included in a single eighteen-bit instruction word, with the condition that the last instruction in the group is selected from a limited set of instructions that require only three bits.

FIG. 4 is a diagrammatic representation of an instruction word 48. (It should be noted that the instruction word 48 can actually contain instructions, data, or some combination thereof.) The instruction word 48 consists of eighteen bits 50. This being a binary computer, each of the bits 50 will be a ‘1’ or a ‘0’. As previously discussed herein, the eighteen-bit wide instruction word 48 can contain up to four instructions 52 in four slots 54 called slot zero 54a, slot one 54b, slot two 54c, and slot three 54d. In the present embodiment, the eighteen-bit instruction words 48 are always read as a whole. Therefore, since there is always a potential of having up to four instructions 52 in the instruction word 48, a no-op (no operation) instruction is included in the instruction set of the computer 12 to provide for instances when using all of the available slots 54 might be unnecessary or even undesirable. It should be noted that, according to one particular embodiment, the polarity (active high as compared to active low) of bits 50 in alternate slots 54 (specifically, slots one 54b and three 54c) is reversed. However, this is not necessary.

FIG. 5 is a schematic representation of the slot sequencer 42 of FIG. 3. As can be seen in the view of FIG. 5, the slot sequencer 42 has a plurality (fourteen in this example) of inverters 56 and one NAND gate 58 arranged in a ring, such that a signal is inverted an odd number of times as it travels through the fourteen inverters 56 and the NAND gate 58. A signal is initiated in the slot sequencer 42 when either of the two inputs to an OR gate 60 goes high. A first OR gate input 62 is derived from an i4 bit 66 (FIG. 4) of the instruction 52 being executed. If i4 bit 66 is high then that particular instruction 52 is an ALU 32 instruction, and the i4 bit 66 is ‘1’. When the i4 bit 66 is ‘1’, then the first OR gate input 62 is high, and the slot sequencer 42 is triggered to initiate a pulse that will cause the execution of the next instruction 52.

When the slot sequencer 42 is triggered, either by the first OR gate input 62 going high or by the second OR gate input 64 going high (as will be discussed hereinbelow), then a signal will travel around the slot sequencer 42 twice, producing an output at a slot sequencer output 68 each time. The first time the signal passes the slot sequencer output 68 it will be low, and the second time the output at the slot sequencer output 68 will be high. The relatively wide output from the slot sequencer output 68 is provided to a pulse generator 70 (shown in block diagrammatic form) that produces a narrow timing pulse as an output. One skilled in the art will recognize that the narrow timing pulse is desirable to accurately initiate the operations of the computer 12.

When the particular instruction 52 being executed is a read or a write instruction, or any other instruction wherein it is not desired that the instruction 52 being executed triggers immediate execution of the next instruction 52 in sequence, then the i4 bit 66 is ‘0’ (low) and the first OR gate input 62 is, therefore, also low. One skilled in the art will recognize that the timing of events in a device such as the computers 12 is generally quite critical, and this is no exception. Upon examination of the slot sequencer 42, one skilled in the art will recognize that the output from the OR gate 60 must remain high until after the signal has circulated past the NAND gate 58 in order to initiate the second “lap” of the ring. Thereafter, the output from the OR gate 60 will go low during that second “lap” in order to prevent unwanted continued oscillation of the circuit.

As can be appreciated in light of the above discussion, when the i4 bit 66 is ‘0’, then the slot sequencer 42 will not be triggered—assuming that the second OR gate input 64, which will be discussed hereinbelow, is not high.

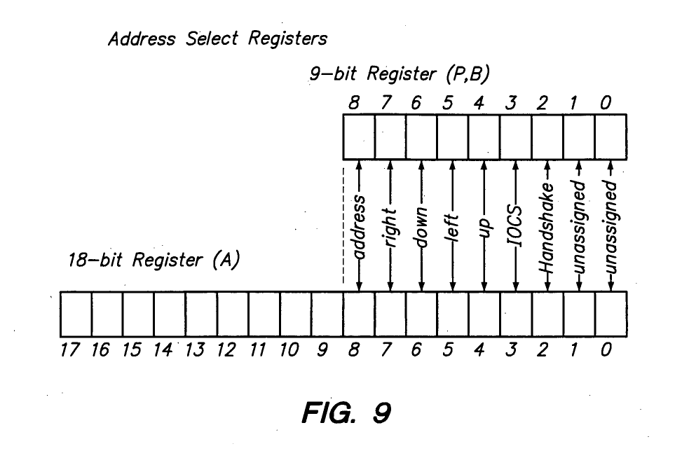

As discussed above, the i4 bit 66 of each instruction 52 is set according to whether or not that instruction is a read or write type of instruction. The remaining bits 50 in the instruction 52 provide the remainder of the particular opcode for that instruction. In the case of a read or write type instruction, one or more of the bits may be used to indicate where data is to be read from or written to in that particular computer 12. In the present example, data to be written always comes from the T register 44 (the top of the data stack 34); however data can be selectively read into either the T register 44 or the instruction area from where it can be executed. In this particular embodiment, either data or instructions can be communicated in the manner described herein and instructions can therefore be executed directly from the data bus 16, although this is not necessary. Furthermore, one or more of the bits 50 will be used to indicate which of the ports 38, if any, is to be set to read or write. This later operation is optionally accomplished by using one or more bits to designate a register 40, such as the A register 40a, the B register 40b, or the like. In such an example, the designated register 40 will be preloaded with data having a bit corresponding to each of the ports 38 (plus, any other potential entity with which the computer 12 may be attempting to communicate, such as memory, an external communications port, or the like.) For example, each of four bits in the particular register 40 can correspond to each of the right port 38a, the down port 38b, the left port 38c, or the up port 38d. In such case, where there is a ‘1’ at any of those bit locations communication will be set to proceed through the corresponding port 38. Registers and the contents thereof will be discussed in greater detail hereinbelow, with reference to FIGS. 9-11.

The immediately following example will assume a communication wherein computer 12e is attempting to write to computer 12c, although the example is applicable to communication between any adjacent computers 12. When a write instruction is executed in a writing computer 12e, the selected write line 20 is set high (in this example, the write line 20 between computers 12e and 12c). If the corresponding read line 18 is already high, then data is immediately sent from the selected location through the selected communications port 38. Alternatively, if the corresponding read line 18 is not already high, then computer 12e will simply stop operation until the corresponding read line 18 does go high. In short, the opcode of the instruction 52 will have a ‘0’ at the i4 bit 66 position, and so the first OR gate input 62 of the OR gate 60 is low, and so the slot sequencer 42 is not triggered to generate an enabling pulse.

The following description explains how the operation of the computer 12e resumes when a read or write type instruction is completed. When both the read line 18 and the corresponding write line 20 between computers 12e and 12c are high, then both lines 18 and 20 will be released by each of the respective computers 12 that is holding it high. (In this example, the sending computer 12e will be holding the write line 20 high, while the receiving computer 12c will be holding the read line 18 high). Then the receiving computer 12c will pull both lines 18 and 20 low. In actual practice, the receiving computer 12c may attempt to pull the lines 18 and 20 low before the sending computer 12e has released the write line 20. However, since the lines 18 and 20 are pulled high and only weakly held (latched) low, any attempt to pull a line 18 or 20 low will not actually succeed until that line 18 or 20 is released by the computer 12 that is latching it high.

When both lines 18 and 20 in a data bus 16 are pulled low, this is an “acknowledge” condition. Each of the computers 12e and 12c will, upon the acknowledge condition, set its own internal acknowledge line 72 high. As can be seen in the view of FIG. 5, the acknowledge line 72 provides the second OR gate input 64. Since an input to either of the OR gate inputs 62 or 64 will cause the output of the OR gate 60 to go high, this will initiate operation of the slot sequencer 42 in the manner previously described herein, such that the instruction 52 in the next slot 54 of the instruction word 48 will be executed. The acknowledge line 72 stays high until the next instruction 52 is decoded, in order to prevent spurious addresses from reaching the address bus.

When the instruction 52 being executed is in the slot three position of the instruction word 48, the computer 12 will retrieve the next awaiting eighteen-bit instruction word 48 unless, of course, the i4 bit 66 is a ‘0’. In actual practice, a method and apparatus for “prefetching” instructions can be included such that the fetch can begin before the end of the execution of all instructions 52 in the instruction word 48. However, this is not necessary for asynchronous data communications.

The above example wherein computer 12e is writing to computer 12c has been described in detail. As can be appreciated in light of the above discussion, the operations are essentially the same whether computer 12e attempts to write to computer 12c first, or whether computer 12c first attempts to read from computer 12e. The operation cannot be completed until both computers 12e and 12c are ready and, whichever computer 12e or 12c is ready first, that first computer 12 simply “goes to sleep” until the other computer 12e or 12c completes the transfer. Another way of looking at the above described process is that, actually, both the writing computer 12e and the receiving computer 12c go to sleep when they execute the write and read instructions, respectively, but the last one to enter into the transaction reawakens nearly instantaneously when both the read line 18 and the write line 20 are high, whereas the first computer 12 to initiate the transaction can stay asleep nearly indefinitely until the second computer 12 is ready to complete the process.

It is believed that a key feature for enabling efficient asynchronous communications between devices is some sort of acknowledge signal or condition. In the prior art, most communication between devices has been clocked and there is no direct way for a sending device to know that the receiving device has properly received the data. Methods such as checksum operations may have been used to attempt to insure that data is correctly received, but the sending device has no direct indication that the operation is completed. The present method, as described herein, provides the necessary acknowledge condition that allows, or at least makes practical, asynchronous communications between the devices. Furthermore, the acknowledge condition also makes it possible for one or more of the devices to “go to sleep” until the acknowledge condition occurs. An acknowledge condition could be communicated between the computers 12 by a separate signal being sent between the computers 12 (either over the interconnecting data bus 16 or over a separate signal line). However, it can be appreciated that there is even more economy involved here, in that the method for acknowledgement does not require any additional signal, clock cycle, timing pulse, or any such resource beyond that described, to actually affect the communication.

In light of the above discussion of the procedures and means for accomplishing them, the following brief description of an example of the previously described method can now be understood. FIG. 6 is a flow diagram 74 depicting this method example. In an ‘initiate communication’ operation 76, one computer 12 executes an instruction 52 that causes it to attempt to communicate with another computer 12. This can be either an attempt to write or an attempt to read. In a ‘set first line high’ operation 78, which occurs generally simultaneously with the ‘initiate communication’ operation 76, either a read line 18 or a write line 20 is set high (depending upon whether the first computer 12 is attempting to read or to write). As a part of the ‘set first line high’ operation 78, the computer 12 doing so will cease operation, as described in detail previously herein. In a ‘set second line high’ operation 80, the second line (either the write line 20 or read line 18) is set high by the second computer 12. In a ‘communicate data’ operation 82, data (or instructions, or the like) is transmitted and received over the data lines 22. In a ‘latch lines low’ operation 84, the read line 18 and the write line 20 are released and then latched low. In a ‘continue’ operation 86, the acknowledge condition causes the computers 12 to resume their operation. In the case of the present example, the acknowledge condition causes an acknowledge signal 88 (FIG. 5) which, in this case, is simply the “high” condition of the acknowledge line 72.

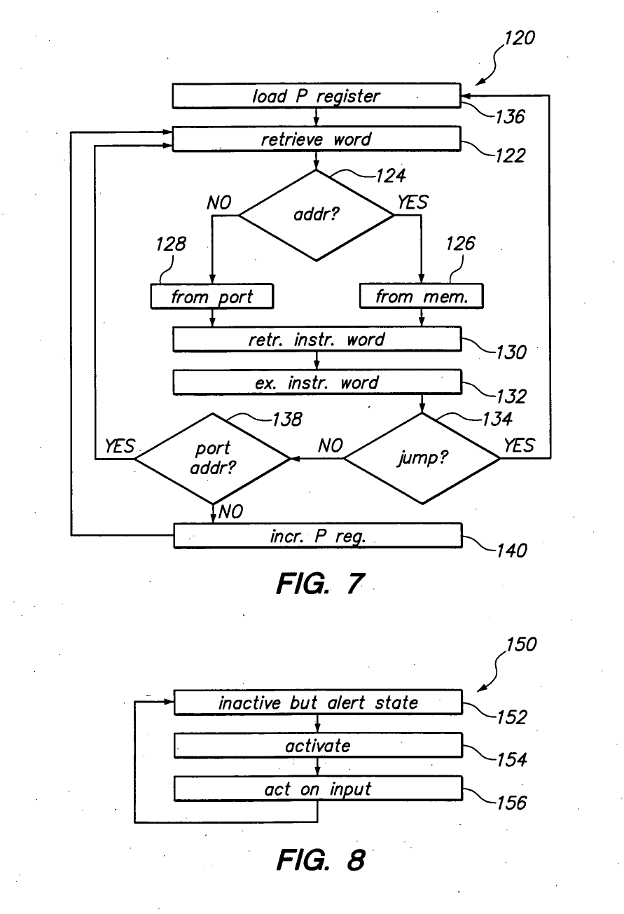

FIG. 7 is a flow diagram depicting an example of the above described direct execution method 120. A “normal” flow of operations will commence when, as discussed previously herein, there are no more executable instructions 52 left in the instruction register 30a. At such time, the computer 12 will “retrieve” another instruction word 48, as indicated by a “retrieve word” operation 122. That operation will be accomplished according to the address in the P register 40c (as indicated by an “address” decision operation 124 in the flow diagram of FIG. 7. If the address in the P register 40c is a RAM 24 or ROM 26 address, then the next instruction word 48 will be retrieved from the designated memory location in a “retrieve from memory” operation 126. On the other hand, if the address in the P register 40c is that of a port 38 or ports 38 (not a memory address) then the next instruction word 48 will be retrieved from the designated port location in a “retrieve from port” operation 128. In either case, the instruction word 48 being retrieved is placed in the instruction register 30c in a “retrieve instruction word” operation 130. In an “execute instruction word” operation 132, the instructions 52 in the slots 54 of the instruction word 48 are accomplished sequentially, as described previously herein.

In a “jump” decision operation 134, it is determined if one of the operations in the instruction word 48 is a JUMP instruction or other instruction 52, that would divert operation away from the continued “normal” progression as discussed previously herein. If yes, then the address provided in the instruction word 48 after the JUMP (or other such) instruction 52 is provided to the P register 40c in a “load P register” operation 136, and the sequence begins again in the “retrieve word” operation 122, as indicated in the diagram of FIG. 7. If no, then the next action depends upon whether the last retrieved instruction 52 was from a port 38 or from a memory address, as indicated in a “port address” decision operation 138. If the last retrieved instruction 52 was from a port 38, then no change is made to the P register 40c and the sequence is repeated starting with the “retrieve word” operation 122. If, on the other hand, the last retrieved instruction 52 was from a memory address (RAM 24 or ROM 26), then the address in the P register 40c is incremented, as indicated by an “increment P register” operation 140 in FIG. 7, before the “retrieve word” operation 122 is accomplished.

The above description is not intended to represent actual operational steps. Instead, it is a diagram of the various decisions and operations resulting therefrom that are performed according to the described embodiment of the invention. Indeed, this flow diagram should not be misconstrued to mean that each operation described and shown requires a separate distinct sequential step. In fact many of the described operations in the flow diagram of FIG. 7 will, in practice, be accomplished generally simultaneously.

FIG. 8 is a flow diagram depicting an example of a method for alerting a processor 150. As previously discussed herein, the processors 12 of the embodiment described will “become inactive” while awaiting an input. Such an input can be from a neighboring processor 12, as in the embodiment described in relation to FIGS. 1 through 4. As was also discussed previously herein, the processors 12 that have communication ports 38 that abut the edge of the die 14 can have additional circuitry, either designed into such processor 12 or external to the processor 12 but associated therewith, to cause such communication port 38 to act as an external I/O port 39. Alternatively, it is within the scope of this invention that any processor 12, including processors 12 within the interior of the die 14, could have additional circuitry to cause its associated communication port 38 to act as an external I/O port 39. In any case, the inventive combination can provide the additional advantage that the “inactive” processor 12 can be poised and ready to activate and spring into some prescribed action when an input is received. This process is referred to as a worker mode.

Each processor 12 is programmed to JUMP to an address when it is started. That address will be the address of the first instruction word 48 that will start that particular processor 12 on its designated job. The instruction word 48 can be located, for example, in the ROM 26. After a cold start, a, processor 12 may load a program, such as a program known as a worker mode loop. The worker mode loop for center processors 12, edge processors 12, and corner processors 12 will be different. In addition, some processors 12 may have specific tasks at boot-up in ROM 26 associated with their positions within the array 10. Worker mode loops will be described in greater detail hereinbelow.

While there are numerous ways in which this feature might be used, an example that will serve to illustrate just one such “computer alert method” is illustrated in the view of FIG. 8 and is enumerated therein by the reference character 150. As can be seen in the view of FIG. 8 in an “inactive but alert state” operation 152, a processor 12 is caused to “become inactive” such that it is awaiting input from a neighbor processor 12, or more than one (as many as all four) neighbor processors 12 or, in the case of an “edge” processor 12 an external input, or some combination of external inputs and/or inputs from a neighbor processor 12. As described previously herein, a processor 12 can “become inactive” awaiting completion of either a read or a write operation. Where the processor 12 is being used, as described in this example, to await some possible “input”, then it would be natural to assume that the waiting processor has set its read line 18 high awaiting a “write” from the neighbor or outside source. Indeed, it is presently anticipated that will be the usual condition. However, it is within the scope of the invention that the waiting processor 12 will have set its write line 20 high and, therefore, that it will become activated when the neighbor or outside source “reads” from it.

In an “activate” operation 154, the inactive processor 12 is caused to resume operation because the neighboring processor 12 or external device has completed the transaction being awaited. If the transaction being awaited was the receipt of an instruction word 48 to be executed, then the processor 12 will proceed to execute the instructions 52 therein. If the transaction being awaited was the receipt of data, then the processor 12 will proceed to execute the next instruction 52 in queue, which will be either the instruction 52 in the next slot 54 in the present instruction word 48, or the next instruction word 48 will be loaded and the next instruction 52 will be in slot 0 of that next instruction word 48. In any case, while being used in the described manner, then that next instruction 52 will begin a sequence of one or more instructions 52 for handling the input just received. Options for handling such input can include reacting to perform some predefined function internally, communicating with one or more of the other processors 12 in the array 10, or even ignoring the input (just as conventional prior art interrupts may be ignored under prescribed conditions). The options are depicted in the view of FIG. 8 as an “act on input” operation 156. It should be noted that, in some instances, the content of the input may not be important. In some cases, for example, it may be only the very fact that an external device has attempted communication that is of interest.

One skilled in the art will recognize that this above-described operating mode will be useful as a more efficient alternative to the conventional use of interrupts. When a processor 12 has one or more of its read lines 18 (or a write line 20) set high, it can be said to be in an “alert” condition. In the alert condition, the processor 12 is ready to immediately execute any instruction 52 sent to it on the data bus 16 corresponding to the read line or lines 18 that are set high or, alternatively, to act on data that is transferred over the data bus 16. Where there is an array of processors 12 available, one or more can be used at any given time to be in the above-described alert condition such that any of a prescribed set of inputs will trigger it into action. This is preferable to using the conventional interrupt technique to “get the attention” of a processor, because an interrupt will cause a processor 12 to have to store certain data, load certain data, and so on, in response to the interrupt request. According to the present invention, a processor 12 can be placed in the alert condition and dedicated to awaiting the input of interest, such that not a single instruction period is wasted in beginning execution of the instructions 52 triggered by such input. Again, note that in the presently described embodiment, processors in the alert condition will actually be “inactive”, meaning that they are using essentially no power, but “alert” in that they will be instantly triggered into action by an input. However, it is within the scope of this aspect of the invention that the “alert” condition could be embodied in a processor even if it were not “inactive”. The described alert condition can be used in essentially any situation where a conventional prior art interrupt (either a hardware interrupt or a software interrupt) might have otherwise been used.

FIG. 9 is a table diagram of a 9-bit address select register 40, such as the B register 40b or P register 40c. Bit 8 is the address bit, where a high value of 1 designates a port address and a low value of 0 designates a memory address. Bits 7, 6, 5, and 4 address the specific ports 38 of right, down, left, and up (RDLU), respectively. A high value to bit 3 designates checking the IOCS register 40d, and a high value to bit 2 designates a required handshake. Typically, a handshake is required when there is a high value to any of the port bits. Bits 0 and 1 can remain unassigned, or be used for other purposes.

FIG. 9 also shows a table diagram of an 18-bit address select register 40, such as the A register 40a. Bits 0-8 of the A register 40a are identical to bits 0-8 of the B 40b and P registers 40c. Bits 9-17 are not used for address purposes. However, the A register 40a can be used as a temporary memory storage, in which case, all 18 bits would be used.

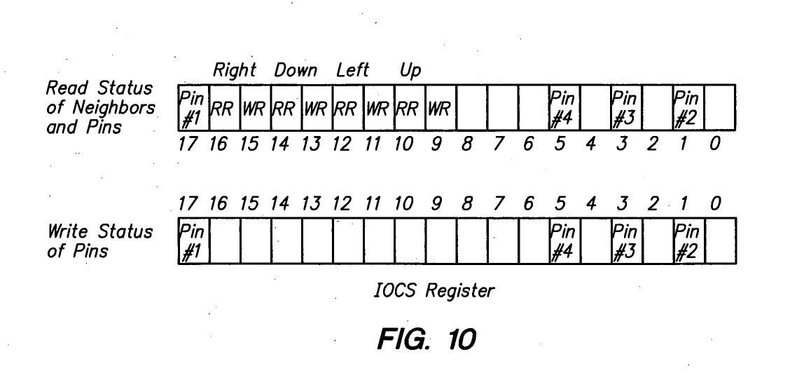

FIG. 10 is a table diagram of an IOCS register 40d. The IOCS register 40d has an 18-bit read register 40 for checking the status of the subject core's neighbor requests, and for checking the input status of any neighboring pin connections. The IOCS register 40d also has an 18-bit write register 40 for checking the output or control status of the subject core's neighboring pin connections. The read and write registers can also contain status information that is specific to a particular core 12. For example, the write status register for node 0 (lower left corner of array 10) also contains the status of the external data bus connection.

When a core 12 checks the IOCS read register 40d, the core 12 is checking the status of what its nearest neighbors are doing relative to itself, i.e., which neighbors are reading from and/or writing to the subject core 12. As shown in FIG. 10, bits 16 and 15 give the read and write status, respectively for the right neighbor core 12. Bits 14 and 13 give the read and write status, respectively for the down neighbor core 12. Bits 12 and 11 give the read and write status, respectively for the left core 12. Bits 10 and 9 give the read and write status, respectively for the up core 12. Bits 17, 1, 3, and 5 give the status of the first, second, third, and fourth pins, respectively for the subject core 12.

The IOCS write register 40d, shown in FIG. 10 is a register 40 for checking the output or control status of any of the pin connections that are connected to the, subject core 12. The write status register requires two bits for every pin connection. The output status of the first pin is designated by bits 16 and 17; the output status of the second pin is designated by bits 0 and 1; the output status of the third pin is designated by bits 2 and 3; and the output status of the fourth pin is designated by bits 4 and 5.

As mentioned previously, any of the remaining bit locations of either the read status or write status register 40 can be used for specialized designations. Both the read and write registers 40 will seldom be completely full for any core 12. As an example, only interior nodes 12 will have designations for all four neighbors in the read status register. Interior nodes 12 will usually have no pin connections, and therefore the write register 40 will be completely empty.

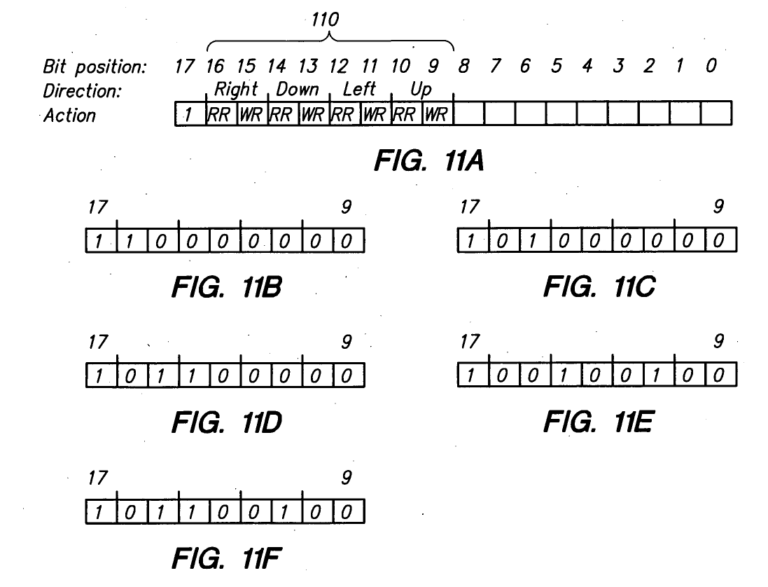

FIGS. 11a-f are table diagrams of an IOCS read status register 40d, showing an overview of port address decoding that is usable in the CPUs 12 of FIG. 2. FIGS. 11a-f illustrate the port status given by bits 9-16 of the IOCS read status register 40d. Bits 9-16 are status bits 110 that specify which particular port 38 or ports 38 are selected and whether the subject processor 12 is reading from or writing to the selected port(s) 38. Thus, for the registers 40 in CPU 12e, “Right” indicates the neighboring rightward CPU 12a, “Down” indicates the neighboring downward CPU 12b, “Left” indicates the neighboring leftward CPU 12c, and “Up” indicates the neighboring upward CPU 12d (see also FIG. 2). A status bit 110 that is set at “RR” indicates an existing read request, and a status bit 110 that is set at “WR” indicates an existing write request.

Note, for consistency and to minimize confusion, the general convention is used here, where a high value or “1” denotes a true condition and a low value or “0” denotes a false condition. This is not a requirement, however, and alternate conventions can be used. For example, some presently preferred embodiments of the CPUs 12 use “0” for true in the RR bit locations and use “1” for true in the WR bit locations.

In present embodiments of the CPUs 12, the IOCS register 40d uses the same port address arrangement to report the current status of the read lines 18 and write lines 20 of the ports 38. This makes these respective bits in the IOCS register 40d useful to permit programmatically testing the status of I/O operations. For example, rather than have CPU 12e commit to an asynchronous read from CPU 12b, wherein CPU 12e will go to sleep if CPU 12b has not yet set the shared write line 20 high, CPU 12e can test the state of bit 13 (Down/WR) in the IOCS register 40d (reflecting the state of the write line 20 that connects CPU 12b to CPU 12e) and either branch to and immediately read the ready data from CPU 12b or branch to and immediately execute another instruction.

FIG. 11b shows a simple first example using a partial view of the IOCS read status register 40d. Here the status bit 110 for Right/RR is set, indicating that port 38a is being read from. FIG. 11c shows a simple second example. Here the status bit 110 for Right/WR is set, now indicating that port 38a is being written to.

More than one of the status bits 110 for the ports 38 may be beneficially enabled at the same time, thus representing multiple read and/or write operations. In such cases, the data is presented on all of the respective ports 38, including a signal that the new data is present.

FIGS. 11d-f show partial views of the IOCS read status register 40d for some examples of multiple read and/or write operations. FIG. 11d shows how a register 40 in CPU 12e can concurrently read from CPU 12b and write to CPU 12a. FIG. 11e shows how a read from CPU 12b and a write to CPU 12e can concurrently exist. And FIG. 11f shows a read from CPU 12b and a write to either CPU 12a or CPU 12c.

In practice during a multiple write, the CPU 12e will present the data and set the write lines 20 high on the buses 16 that it shares with one or more of the target CPUs 12a, 12b, 12c, or 12d. The source CPU 12e then will wait until it receives an indication that the data has been read. At some eventual point, presumably, one or more of the target CPUs 12a, 12b, 12c, or 12d will set its respective read line 18 high on the bus 16 shared with CPU 12e. A target CPU 12 then formally reads the data and latches both the respective read line 18 and write line 20 on the bus 16 shared with CPU 12e, thus acknowledging receipt of the data from CPU 12e.

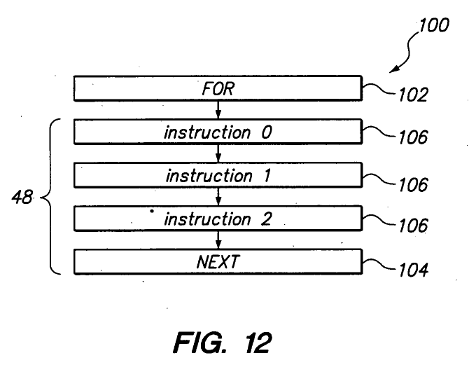

Since four instructions 52 can be included in an instruction word 48, and since an entire instruction word 48 can be communicated at one time between computers 12, this presents an ideal opportunity for transmitting a very small program in one operation. For example, most of a small “For/Next” loop can be implemented in a single instruction word 48. FIG. 12 is a diagrammatic representation of a micro-loop 100. The micro-loop 100, not unlike other prior art loops, has a FOR instruction 102 and a NEXT instruction 104. Since an instruction word 48 (FIG. 4) contains as many as four instructions 52, an instruction word 48 can include three operation instructions 106 within a single instruction word 48. The operation instructions 106 can be essentially any of the available instructions that a programmer might want to include in the micro-loop 100. A typical example of a micro-loop 100 that might be transmitted from one computer 12 to another might be a set of instructions 52 for reading from, or writing to the RAM 24 of the second computer 12, such that the first computer 12 could “borrow” available RAM 24 capacity.

The FOR instruction 102 pushes a value onto the return stack 28 representing the number of iterations desired. That is, the value on the T register 44 at the top of the data stack 34 is PUSHed onto the R register 29 of the return stack 28. The FOR instruction 102, while often located in slot two 54c of an instruction word 48 can, in fact, be located in any of slots zero 54a, one 54b, or two 54c.

The NEXT instruction 104 depicted in the view of FIG. 12 is a particular type of NEXT instruction 104 because it is located in slot three 54d (FIG. 4). It is assumed that all of the data in a particular instruction word 48 that follows an “ordinary” NEXT instruction 104 (not shown) is an address (the address where the for/next loop begins). The opcode for the NEXT instruction 104 is the same, no matter which of the four slots 54 it is in (with the exception that the last two digits are assumed when it is located in slot three 54d, rather than being explicitly written). However, since there can be no address data following the NEXT instruction 104 when it is in slot three 54d, it can also be assumed that the NEXT instruction 104 in slot three 54d is a MICRO-NEXT instruction 104a. The MICRO-NEXT instruction 104a uses the address of the first instruction 52, located in slot zero 54a of the same instruction word 48 in which it is located, as the address to which to return. The MICRO-NEXT instruction 104a also takes the value from the R register 29 (which was originally PUSHed there by the FOR instruction 102), decrements it by 1, and then returns it to the R register 29. When the value on the R register 29 reaches a predetermined value (such as zero), then the MICRO-NEXT instruction 104a will load the next instruction word 48 and continue on as described previously herein. However, when the MICRO-NEXT instruction 104a reads a value from the R register 29 that is greater than the predetermined value, it will resume operation at slot zero 54a of its own instruction word 48 and execute the three instructions 52 located in slots zero through two, inclusive. That is, a MICRO-NEXT instruction 104a will always, in this embodiment of the invention, execute three operation instructions 106. Because, in some instances, it may not be desired to use all three potentially available instructions 52, a “no-op” instruction is available to fill one or two of the slots 54, as required.

The ability to execute an entire micro-loop 100 within a single instruction word 48 can be combined with the ability to allow a computer 12 to send the instruction word 48 to a neighbor computer 12 to execute the instructions 52 therein, essentially directly from the data bus 16. The small micro-loop 100, all contained within the single instruction word 48, can be communicated between computers 12, as described herein, and it can be executed directly from the communications port 38 of the receiving computer 12, just like any other set of instructions 52 contained in an instruction word 48. While there are many uses for this sort of “micro-loop” 100, a typical use would be where one computer 12 wants to store some data onto the memory of a neighbor computer 12. It could, for example, first send an instruction 52 to that neighbor computer telling it to store an incoming data word to a particular memory address, then increment that address, then repeat for a given number of iterations (the number of data words to be transmitted). To read the data back, the first computer 12 would just instruct the second computer 12 (the one used for storage here) to write the stored data back to the first computer 12, using a similar micro-loop 100.

By using the micro-loop 100 structure in conjunction with the direct execution aspect described herein, a computer 12 can use an otherwise resting neighbor computer 12 for storage of excess data when the data storage need exceeds the capacity built into each individual computer 12. While this example has been described in terms of data storage, the same technique can equally be used to allow a computer 12 to have its neighbor share its computational resources—by creating a micro-loop 100 that causes the other computer 12 to perform some operations, store the result, and repeat a given number of times.

Other ways in which a micro-loop 100 can be used are the following. RSHIFT (2/) shifts the value in the T register 44 to the right one bit position. A micro-loop 100 can repeat this function a set number of times. Similarly, LSHIFT (2*) shifts the value in the T register 44 to the left one bit position, which can be repeated in a micro-loop 100. PLUS STAR (+*) can also be used in a micro-loop 100 to combine partial products a set number of times. As can be appreciated, the number of ways in which this inventive micro-loop 100 structure can be used is nearly infinite.

As previously mentioned herein, in the presently described embodiment of the invention, either data or instructions can be communicated in the manner described herein and instructions can therefore, be executed essentially directly from the data bus 16. That is, there is no need to store instructions to RAM 24 and then recall them before execution. Instead, according to this aspect of the invention, an instruction word 48 that is received on a communications port 38 is not treated essentially differently than it would be if it were recalled from RAM 24 or ROM 26.

One of the available machine language instructions is a FETCH instruction. The FETCH instruction uses the address on the A register 40a, which was previously placed there to determine from where to fetch an 18 bit word. As previously discussed herein, the A register 40a is an 18 bit register, such that there is a sufficient range of address data available that any of the potential sources from which a fetch can occur can be differentiated. In addition, the 9-bit B register 40b or P register 40c could also be utilized. That is, there is a range of addresses assigned to ROM 26, a different range of addresses assigned to RAM 24, and there are specific addresses for each of the ports 38 and for the external I/O port 39. A FETCH instruction always places the 18 bits that it fetches onto the T register 44.

In contrast, as previously discussed herein, executable instructions (as opposed to data) are temporarily stored in the instruction register 30a. There is no specific command for “retrieving” an 18 bit instruction word 48 into the instruction register 30a. Instead, when there are no more executable instructions remaining in the instruction register 30a, the computer 12 will automatically retrieve the “next” instruction word 48. Where that “next” instruction word 48 is located is determined by the “program counter” (the P register 40c). The P register 40c is often automatically incremented, as is the case where a sequence of instruction words 48 is to be retrieved from RAM 24 or ROM 26. However, there are a number of exceptions to this general rule. For example, a JUMP or CALL instruction will cause the P register 40c to be loaded with the address designated by the data in the remainder of the presently loaded instruction word 48 after the JUMP or CALL instruction, rather than being incremented. When the P register 40c is then loaded with an address corresponding to one or more of the ports 38, then the next instruction word 48 will be loaded into the instruction register 30a from the designated ports 38. The P register 40c also does not increment when an instruction word 48 has just been retrieved from a port 38 into the instruction register 30a. Rather, it will continue to retain that same port address until a specific JUMP or CALL instruction is executed to change the P register 40c. That is, once the computer 12 is told to look for its next instruction from a port 38, it will continue to look for instructions from that same port 38 (or ports 38) until it is told to look elsewhere, such as back to the memory (RAM 24 or ROM 26) for its next instruction word 48.

As noted above, the computer 12 knows that the next eighteen (18) bits retrieved are to be placed in the instruction register 30a when there are no more executable instructions 52 left in the present instruction word 48. By default, there are no more executable instructions 52 left in the present instruction word 48 after a JUMP or CALL instruction (or also after certain other instructions that will not be specifically discussed here) because, by definition, the remainder of the 18 bit instruction word 48 following a JUMP or CALL instruction is dedicated to the address referred to by the JUMP or CALL instruction. Another way of stating this is that the above described processes are unique in many ways, including but not limited to the fact that a JUMP or CALL instruction can, optionally, be to a port 38, rather than to just a memory address, or the like.

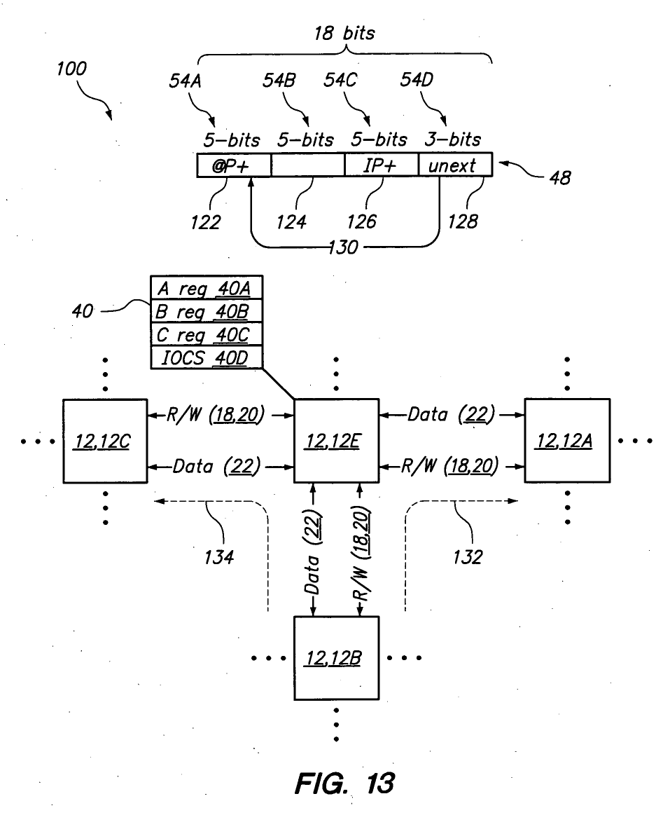

FIG. 13 is a schematic block diagram depicting how the multiple-write approach illustrated in FIGS. 11d-f can particularly be combined with an ability to include up to four instructions 52 in one instruction word 48. As previously stated, an instruction word 48 can contain instructions, data, or some combination thereof. Each instruction 52 is typically five bits, so the 18-bit wide instruction word 48 holds about four instructions 52. The last instruction 52 can be only three bits, but that is sufficient for many instructions 52. One notably beneficial aspect of this is that it permits using very efficient data transfer mechanisms.

In the following discussion, @=fetch, !=store, and p refer to the “program counter” or P register 40c. The “+” in @p+ and !p+ refer to incrementing a memory address in the register 40 after execution, except that the register content is not incremented if it addresses another register 40 or a port 38.

FIG. 13 presents an example of how a single instruction-sequence program to transfer data from one CPU 12 to another can be included in a single 18-bit instruction word 48 with just the P register 40c used to read and write the data. Here “@p+” is the instruction 122 loaded in slot zero 54a. This is a literal operation that fetches the next 18-bit instruction word 48 from the current address specified in the P register 40c, and pushes that instruction word 48 onto the data stack 34. Generally, this would increment the address in the P register 40c, except that this is not done when that address is for a register 40 or a port 38, and here the address bit in the P register 40c will indicate that ports 38 are being specified. Next, “.” is the instruction 124 loaded in slot one 54b. This is a simple nop operation (no operation) that does nothing. And next, “!p+” is the instruction 126 loaded in slot two 54c. This is a store operation that pops the top instruction word 48 from the data stack 34, and writes this 18-bit instruction word 48 to the current address specified in the P register 40c. Note, that the address specified in the P register 40c has not changed; it just functionally causes different neighboring CPUs 12 to be accessed. Finally, “μnext” is the instruction 128 loaded in slot three 54d. This is a MICRO-NEXT 104a operation that operates differently depending on whether the top of the return stack 28 is zero. When the return stack 28 is not zero, the MICRO-NEXT 104a causes the return stack 28 to be decremented and for execution to continue at the instruction 52 in slot zero 54a of the currently cached instruction word 48 (again, that is at instruction 122 in the example here). Note particularly, the use of the MICRO-NEXT 104a here does not require a new instruction word 48 to be fetched. In contrast, when the return stack 28 is zero, the MICRO-NEXT 104a fetches the next instruction word 48 from the current address specified in the P register 40c, and causes execution to commence at the instruction 52 in slot zero 54a of that new instruction word 48.

For this particular example shown in FIG. 13, the “@p+” in instruction 122 instructs CPU 12e to read (via its port 38b) a next instruction word 48 from CPU 12b and to push that instruction word 48 onto the data stack 34. The address in the P register 40c is not incremented, however, since that address is for a port 38. The “.” nop in instruction 124 balances the micro-next instruction in timing the input and output, and the nop fills up the 18 bits of the current instruction word 48. Next, the “!p+” in instruction 126 instructs CPU 12e to pop the top instruction word 48 off of the data stack 34 (the very same instruction word 48 just put there by instruction 122) and to write that instruction word 48 (via port 38a) to CPU 12a. Again, the address in the P register 40c is not incremented because that address is for a port 38. Then the “μnext” in instruction 128 causes the return stack 28 to be decremented, and for execution to continue at instruction 122. The single word program in instructions 122, 124, 126, and 128 continues in this manner, decrementing the return stack 28, and ultimately fetching the next instruction word 48 from CPU 12b, and executing the instruction 52 in slot zero 54a of this new instruction word 48.

In summary, the P register 40c in the example here is loaded with one address value that specified both a source and destination (ports 38b and 38a, and thus CPUs 12b and 12a); the return stack 28 has been loaded with an iteration count (5). Then five instruction words 48 are efficiently transferred (“pipelined”) through CPU 12e, which then continues at the instruction 52 in slot zero 54a of a sixth instruction word 48 also provided by CPU 12b.

Various other advantages flow from the use of this simple but elegant approach. For instance, the A register 40a and the B register 40b need not be used and thus can be employed by CPU 12e for other purposes. Following from this, pointer swapping or thrashing (repeatedly changing between a small number of values) can also be eliminated when performing data transfers.

This particular micro-program is contained within a single instruction word 48, which provides a loop inside of an instruction word 48. Since this micro-program contains both the sender and recipient port 38 addresses, there is no need to reload the P register 40c or reload instructions from memory. The micro-program illustrated in FIG. 13 acts as a port pump by reading from one neighbor port 38 and writing to another neighbor port 38 repeatedly until a predetermined value is reached on the R register 29 of the return stack 28. This provides a symmetrical feeding of instructions between two neighboring CPUs 12 without having to change the, address or pointer. This is achieved by designating both a read or fetch port 38 location and a store or write port 38 location in the P register 40c.

A port pump provides the advantages of a reversible and shorter instruction loop, all contained within a single instruction word 48. Port pump advantages can also be realized using multiple address registers, such as using the P register 40c for a port address and the A register 40a for a memory address. The MICRO-NEXT instruction 104a would read:

| | |
|---|---|
| @p⁺ . !a⁺ μnext | or also |
| @a⁺ . !p⁺ μnext | |

It is also within the scope of this invention to incorporate multiple reads and writes within the same core 12, as long as the participating neighboring cores 12 cooperate and synchronize with the subject core 12. This can be accomplished in several ways with a combination of address registers 40 or a single address register 40.

Another example of a port pump using the MICRO-NEXT instruction 104a is the following:

@p+ !a+ μnext;

or also,

@a+ !p+ μnext;

The MICRO-NEXT loop will continue until a predetermined value in the R register 29 of the return stack 28 is reached, then that value is discarded. Then the semicolon (;) points to the address specified in the current R register 29.

In contrast to the above-described procedure, a conventional software routine for data pipelining would at some point read data from an input port and at another point write data to an output port. For this, at least one pointer into memory would be needed, in addition to pointers to the respective input and output ports that are being used. Since the ports would have different addresses, the most direct way to proceed here would be to load the input port address onto a stack with a literal instruction, put that address into an addressing register, perform a read from the input port, then load the address of the output port onto the stack with a literal instruction, put that address into an addressing register, and perform a write to the output port. The two literal loads in this approach would take 4 cycles each, and the two register set instructions will take 1 cycle each. That is a total of 10 cycles spent inside of the loop just on setting the input and output pointers. Furthermore, there is an additional penalty when such pointer swapping is needed because three words of memory are required inside of the loop, thus not allowing the use of a loop contained inside a single 18-bit word. Accordingly, an instruction loop in this example will require a branch with a memory access, which adds 4 cycles of further overhead and makes the total pointer swap and loop overhead at least 14 cycles.

Since multi-port addressing is possible in the CPU 12, the address that selects both the input port 38 and the output port 38 can be loaded outside of an I/O loop and used for both input and output. This approach works because data from only one neighbor is read during a multi-port read and only one neighbor reads during a multi-port write. Thus the 14-cycle overhead inside of a loop that would traditionally be spent setting the input and output pointers is not needed. The loop still has a read instruction and a write instruction, but these can now both use the same pointer, so it does not have to be changed.

This means that the use of the multi-port write technique can reduce the overhead of some types of I/O loops by 14 cycles (or more). It has been the inventors' observation that, in the best case, this permits a reduction from 23 cycles to 6 cycles in the processing loop of a CPU 12. In a situation where one cycle takes approximately one nanosecond, this represents an increase from 43 MHz to 167 MHz in effective processor speed, which represents a considerable improvement.

FIGS. 11f and 13 show how multi-writes can be performed even with single word programs. In FIG. 13, data transfer path 132 displays how CPU 12e reads from CPU 12b and writes to CPU 12a. Likewise, data transfer path 134 displays how CPU 12e reads from CPU 12b and writes to CPU 12c. Here the CPU 12e reads from CPU 12b and writes to either of CPU 12a or CPU 12c. In effect, the pipelining here is to the first available of CPU 12a or CPU 12c. This illustrates the added flexibility possible in the CPUs 12, and is merely one possible example of how CPUs 12 in accord with the present invention are useful in ways previously thought to be too difficult or impractical.

If a CPU 12 executes from a multiport address, and all of the addressed neighboring CPUs 12 are writing cooperatively (i.e., synchronized), one neighbor CPU 12 can be supplying the instruction stream while different CPUs 12 provide the literal data. The literal fetch opcode (@p+) causes a read from the multi-port address in the P register 40c that selectively (not all literals need to do this) can be satisfied by different neighboring CPUs 12. This merely requires extensive “cooperation” between the neighboring CPUs 12.

In the pipeline multi-port usage, where one neighboring CPU 12 is reading and one CPU 12 is writing, reads and writes to the same multi-port address do not cause problems. Jumping to such a multi-port address and executing the literal store opcode (!p+) allows the P register 40c to address two ports 38 with complete safety. This frees up BOTH the A register 40a and the B register 40b for local use.

Various additional modifications may be made to the present invention without altering its value or scope. For example, while this invention has been described herein in terms of read instructions and write instructions, in actual practice there may be more than one read type instruction and/or more than one write type instruction. As just one example, in one embodiment of the computers 12 there is a write instruction that increments the register and other write instructions that do not. Similarly, write instructions can vary according to which register 40 is used to select communications ports 38, or the like, as discussed previously herein. There can also be a number of different read instructions, depending only upon which variations the designer of the computers 12 deems to be a useful choice of alternative read behaviors.

Similarly, while the present invention has been described herein in relation to communications between computers 12 in an array 10 on a single die 14, the same principles and method can be used, or modified for use, to accomplish other inter-device communications, such as communications between a computer 12 and its dedicated memory or between a computer 12 in an array 10 and an external device (through an input/output port, or the like). Indeed, it is anticipated that some applications may require arrays of arrays—with the presently described inter device communication method being potentially applied to communication among the arrays of arrays.

While specific examples of the computer array 10 and computer 12 have been discussed herein, it is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

1. A microprocessor communications system, comprising:
a plurality of interconnected microprocessors arranged in a matrix on a chip, including a first microprocessor and an adjacent second microprocessor,
wherein said first microprocessor is used to store cumulative incoming data into respective cumulative memory addresses, transmitted from said adjacent second microprocessor, and
wherein a single instruction word is used to achieve said stored cumulative incoming data into respective cumulative memory addresses of said first microprocessor transmitted from said adjacent second microprocessor.

2. The communications system of claim 1, wherein said adjacent second microprocessor is used to store said cumulative incoming data which is transmitted back from said first microprocessor.

3. The communications system of claim 1, wherein said first microprocessor is used as data storage by said adjacent second microprocessor.

4. The communications system of claim 1, further comprising:
computational results of said incoming data from said adjacent second microprocessor, which is computed and stored into said respective cumulative memory addresses of said first microprocessor.

5. The communications system of claim 1, wherein said single instruction word comprises a programming loop, and
wherein said first microprocessor used to store cumulative incoming data and said adjacent second microprocessor used to transmit said cumulative data comprise a port pump.

6. The communications system of claim 1, wherein a single address select structure contains the addresses of said first microprocessor used for storage and said adjacent second microprocessor used for transmitting.

7. The communications system of claim 1, wherein said single instruction word is retrieved from a microprocessor communications port.

8. The communications system of claim 1, wherein said single instruction word comprises a complete loop of reading and writing data between said first microprocessor and said adjacent second microprocessor, and
wherein said complete loop is retrieved simultaneously in said single instruction word.

9. The communications system of claim 8, wherein said single instruction word comprises a port pump between said first microprocessor and said adjacent second microprocessor.

10. The communications system of claim 1, wherein said single instruction word further comprises a decrementer function.

11. A microprocessor activity status monitor, comprising:
a monitoring structure which indicates whether a microprocessor is reading instructions and/or data from a directly connected neighboring microprocessor;
a monitoring structure which indicates whether said microprocessor is writing instructions and/or data to a directly connected neighboring microprocessor;
a monitoring structure which indicates the input pin connection status of said microprocessor; and
a monitoring structure which indicates the output pin connection status of said microprocessor.

12. The activity status monitor of claim 11, wherein said monitor comprises a register.

13. The activity status monitor of claim 11, further comprising a monitoring structure which indicates the status for one of a connected analog-to-digital converter and a connected digital-to-analog converter.

14. The activity status monitor of claim 11, further comprising a monitoring structure which indicates the status of an external data bus connection.

15. A microprocessor architecture, comprising:
a read only memory (ROM) portion;
a random access memory (RAM) portion;
a plurality of communication ports for communicating with one of an adjacent microprocessor, a pin connection, and an external device;
an arithmetic logic unit (ALU);
an instruction area;
a plurality of address select structures;
an activity status monitor of directly connected neighboring microprocessors and pin connections;
a plurality of datapath enable drivers;
a plurality of RAM and ROM enable drivers;
a multiplexer which selects one of said ROM or said RAM for input onto an input data bus;
an instruction sequencer mechanism for selecting a next instruction to be executed; and
a timing mechanism for setting a required timing of an instruction.

16. The microprocessor architecture of claim 15, wherein said communication ports comprise an off status, and a receive status for driving a signal into said microprocessor, and a send status for driving a signal out of said microprocessor.

17. The microprocessor architecture of claim 15, wherein said instruction area comprises an instruction register that is capable of receiving one instruction word.

18. The microprocessor architecture of claim 15, wherein said instruction area is further divided into a set number of slots, and an instruction word is divided into a set number of individual opcodes, wherein each one of said set number of individual opcodes is located in a respective one of each of said set number of slots.

19. The microprocessor architecture of claim 15, wherein said activity status monitor comprises:
a monitoring structure which indicates whether a microprocessor is reading instructions and/or data from a directly connected neighboring microprocessor;
a monitoring structure which indicates whether said microprocessor is writing instructions and/or data to a directly connected neighboring microprocessor;
a monitoring structure which indicates the input pin connection status of said microprocessor; and
a monitoring structure which indicates the output pin connection status of said microprocessor.

20. The microprocessor architecture of claim 15, wherein some of said plurality of address select structures comprise:
an indicator for each of said plurality of communication ports;
an indicator for checking said activity status monitor; and
an indicator for a required communications handshake.

21. The microprocessor architecture of claim 15, wherein said microprocessor comprises a stack based computer.

22. The microprocessor architecture of claim 21, wherein said microprocessor comprises a dual stack based computer.

23. The microprocessor architecture of claim 21, wherein said stack is connected to a bi-directional stack selector.

24. The microprocessor architecture of claim 23, wherein a plurality of registers of said bi-directional stack selector are interconnected, such that said stack operates in a circular repeating pattern.

25. A microprocessor stack register selector, comprising:
a plurality of stack registers, arranged and interconnected in a stack;
a plurality of one-bit shift registers, arranged in a stack;
a plurality of read lines, wherein each one of said plurality of read lines individually interconnects one of said plurality of stack registers to a respective one of said plurality of shift registers;
a plurality of write lines, wherein each one of said plurality of write lines individually interconnects one of said plurality of stack registers to a respective one of said plurality of shift registers; and
a plurality of shift register interconnecting lines, wherein each one of said plurality of shift register interconnecting lines individually connects one shift register to another shift register to form a shift register interconnection network.

26. The stack register selector of claim 25, wherein said interconnection network causes some of said plurality of stack registers to operate in a circular repeating pattern.

27. The stack register selector of claim 26, wherein said interconnection network avoids underfilling and overflowing of said plurality of stack registers.

28. The stack register selector of claim 25, wherein each of said plurality of interconnecting lines interconnect said plurality of shift registers in an alternating pattern.

29. The stack register selector of claim 25, wherein said interconnection network causes some of said plurality of stack registers to operate in a circular repeating pattern for a read instruction, and said interconnection network causes some of said plurality of stack registers to operate in an oppositely directed circular repeating pattern for a write instruction.

30. A method of operating a microprocessor stack register selector, comprising:
arranging and interconnecting a plurality of stack registers in a stack;
arranging and interconnecting a plurality of one-bit shift registers in a stack;
interconnecting each one of a plurality of read lines individually from one of a plurality of shift registers to a respective one of a plurality of stack registers;
interconnecting each one of a plurality of write lines individually from one of a plurality of shift registers to a respective one of a plurality of stack registers;
setting a first of said plurality of shift registers to a high value;
retrieving a first instruction;
selecting a stack register that is interconnected to said first shift register, according to said retrieved first instruction;
executing said first instruction;
setting a second of said plurality of shift registers to a high value, according to said first instruction;
retrieving a second instruction;
selecting a stack register that is interconnected to said second shift register, according to said retrieved second instruction; and
executing said second instruction.

31. The method of claim 30, wherein said first instruction and said second instruction are read instructions.

32. The method of claim 30, wherein said first instruction and said second instruction are write instructions.

33. The method of claim 30, wherein additional steps of setting another shift register to a high value, retrieving another instruction, selecting another stack register that is interconnected to said another shift register, and executing said another instruction are repeated, such that subsequent selecting of said another stack register forms a circular repeated selection of multiple stack registers.
